(19) United States
(12) Patent Application Publication
(10) Pub. No.: US 2005/0141592 A1
(43) Pub. Date: Jun. 30, 2005

(54) Test element for analyzing sample material

(76) Inventors: Gregor Ocvirk, Mannheim (DE); Stefan Kalveram, Viernheim (DE); Bernd Roesicke, Viernheim (DE)

Correspondence Address: MCDONNELL BOEHNEN HULBERT & BERGHOFF LLP, 300 SOUTH WACKER DRIVE, SUITE 3200, CHICAGO, IL, 60606, US

(21) Appl. No.: 11/013,048

(22) Filed: Dec. 15, 2004

(30) Foreign Application Priority Data
Dec. 16, 2003 (DE) DE 103 59 160.5

(51) Int. Cl. G01K 7/00

(52) U.S. Cl. 374/185

(57) ABSTRACT

A test element for analysing sample material such as blood or urine comprising a test carrier which has an analytical area to which sample material can be applied, and a heating element in heat conducting contact with the analytical area. The heating element integrated into the test carrier is formed by a thermistor which self-heats and self-regulates to a preset target temperature when current flows through it.

### CROSS-REFERENCE TO RELATED APPLICATIONS

This application claims priority under 35 U.S.C. § 119, via the Paris Convention for the Protection of Industrial Property, to German patent application number DE 103 59 160.5, filed Dec. 16, 2003, which is hereby incorporated by reference.

### BACKGROUND OF THE INVENTION

(1) Field of the Invention

The present invention concerns a test element for analysing sample material such as blood or urine comprising a test carrier which has an analytical area to which sample material can be applied, and a heating element in heat conducting contact with the analytical area.

(2) Description of Related Art

The use of disposable test strips in portable hand devices and single-use cartridges in stationary measuring instruments enables analytical parameters such as blood gases and blood electrolytes, various metabolites such as glucose in whole blood, serum, tissue fluid or urine to be determined in a timely and economic manner and also allows the determination of blood coagulation values for adjusting coagulation inhibitors. In most of the said test elements there is at least a specific reaction of a reagent with the analyte of interest in a defined analytical area. The reaction rate and thus also the result of the measurement after a certain reaction time is dependent on the temperature of the measuring field. However, a high reproducibility and accuracy of the analytical results is an important prerequisite for deriving therapeutic measures.

In this connection it is known that the test carrier can be heated by a heater in the instrument which allows the desired temperature to be set before the measurement. However, this requires that an adequately long heating period precedes the actual measurement which increases the measuring time and the energy requirements. Also due to the required positioning accuracy, it is difficult to locally heat small test fields.

### BRIEF SUMMARY OF THE INVENTION

It is against the above background that the present invention provides certain unobvious advantages and advancements over the prior art. In particular, the inventors have recognized a need for improvements in test elements intended as consumables of the type stated above in such a manner that reproducible measuring conditions are ensured with economical manufacturing processes and uncomplicated apparatus.

In accordance with one embodiment of the present invention, a test element for analysing sample material such as blood or urine is provided, the test element comprising a test carrier which has an analytical area to which sample material can be applied, and a heating element in heat conducting contact with the analytical area, wherein the heating element integrated into the test carrier is formed by a thermistor which self-heats and self-regulates to a preset target temperature when current flows through it.

The present invention is based on the idea of integrating a temperature control circuit with an inherent command variable into the test carrier. Correspondingly, according to the present invention, the heating element integrated into the test carrier is formed by a thermistor which self-heats and self-regulates to a preset target temperature when current flows through it. The thermistor heats itself substantially independently of the ambient temperature to a target or equilibrium temperature at which the supplied electrical power is equal to the released heat output. If the temperature decreases, the thermistor picks up more electrical power due to its reduced resistance and the temperature increases again. Conversely, there is a sharp rise in the resistance at elevated temperatures which correspondingly reduces the current strength. This allows a self-regulating heating directly on the test element without requiring temperature sensors and heating and control devices in the instrument. This also reduces the size and costs of the instruments. The integration of both the heating and test field into the test element enables a specific tempering with a low energy requirement thus dispensing with external heat transfer resistances. It also enables a very constant test temperature to be achieved.

Although the present invention is not limited to specific advantages or functionality, it is noted that the thermistor as a PTC (positive temperature coefficient) resistor has a sharp non-linear rise in resistance in the region of the target temperature as the temperature increases to enable an exact temperature limitation.

Also, in order to optimize heat exchange with the analytical field, the thermistor can be designed as a heating field, typically as a thin layer heating field. This can be achieved by integrating the thermistor as a flat structure into the test carrier, typically by means of a coating or printing process.

In accordance with another embodiment of the present invention, the thermistor can be made of a composite material comprising a binding agent and electrically conductive components incorporated therein. For the desired self-regulation, the composite material can go through a phase transition which influences the electrical conductivity at the target temperature.

According to yet another embodiment of the present invention, the binding agent can be composed of monomers or polymers while the conductive components can comprise particles of carbon black, carbon fibres, metal threads or conductive polymer particles.

In a typical use, the test carrier is provided as a disposable article for single analyses.

In order to simplify the manufacture and use, the test carrier can comprise a flat substrate, in particular, a test strip typically designed as a composite foil part.

In order to utilize the generated heat in a targeted manner the analytical area can be at least partially bounded by the thermistor or connected to the thermistor by an intermediate foil in a heat-conducting manner. In this case the analytical area and the thermistor should of course have an adequate thermal conductivity.

The analytical area can comprise a reaction field coated with dry chemicals which responds to analytes in the applied liquid sample material. In order to preheat the sample material, the thermistor typically extends beyond the analytical area to a sample supply channel of the test carrier.

For the test evaluation, the thermistor can also form a temperature sensor for determining the analytical temperature by means of a resistance measurement.

Energy can be supplied by arranging connections for a voltage source in the instrument typically formed by conducting paths on the test carrier that are connected to the thermistor.

For biotests the target temperature is typically in a range between about 25 and about 50° C., more typically between about 30 and about 40° C. with a deviation from the target value of less than about 1° C.

In accordance with still another embodiment of the present invention, a measuring instrument, in particular a portable blood sugar or blood coagulation measuring instrument for processing self-heating test elements, is provided.

These and other features and advantages of the present invention will be more fully understood from the following detailed description of the invention taken together with the accompanying claims. It is noted that the scope of the claims is defined by the recitations therein and not by the specific discussion of features and advantages set forth in the present description.

### BRIEF DESCRIPTION OF THE DRAWINGS

The following detailed description of the embodiments of the present invention can be best understood when read in conjunction with the following drawings, where like structure is indicated with like reference numerals and in which:

FIG. 1 shows a block schematic diagram of a portable blood sugar measuring instrument with an insertable test element in accordance with an embodiment of the present invention;

FIGS. 2 and 3 show a perspective diagram of the assembly and an exploded view of the test element in accordance with an embodiment of the present invention; and

FIG. 4 shows the test element in cross-section in accordance with an embodiment of the present invention.

Skilled artisans appreciate that elements in the figures are illustrated for simplicity and clarity and have not been necessarily drawn to scale. For example, the dimensions of some of the elements in the figures may be exaggerated relative to other elements to help improve understanding of the embodiments of the present invention.

### DETAILED DESCRIPTION OF THE INVENTION

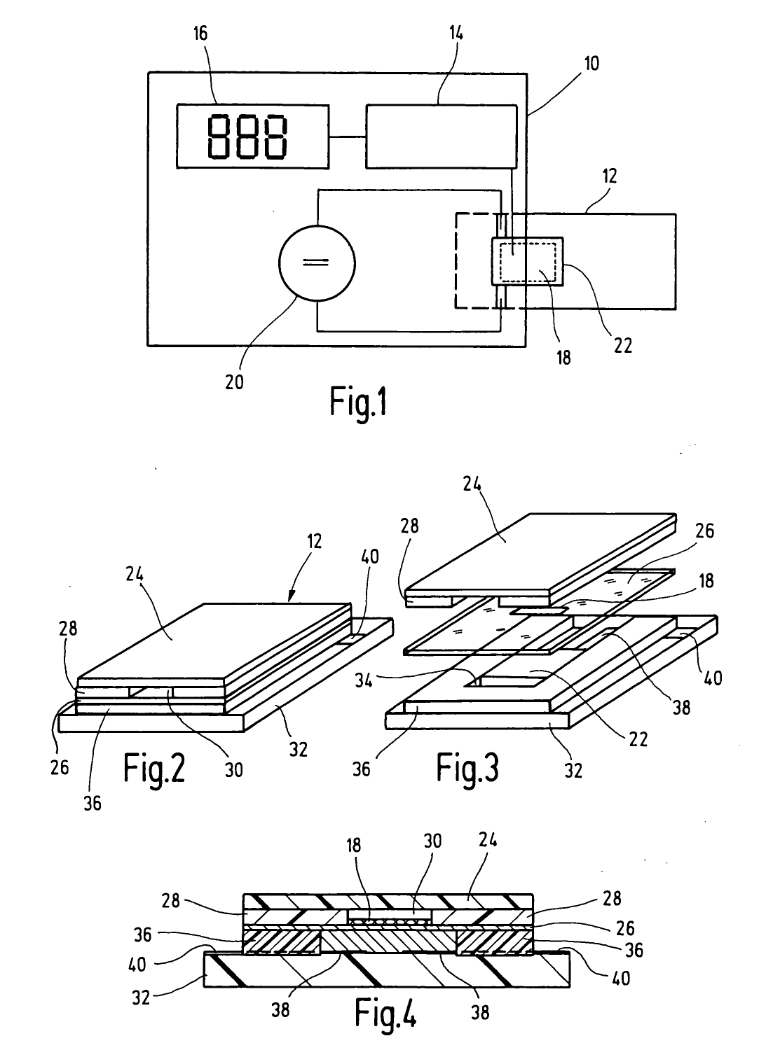

Referring initially to FIG. 1, in accordance with one embodiment of the present invention, a portable blood sugar measuring instrument 10 is shown that enables a disposable strip-shaped test element 12 to be processed by means of a measuring and evaluation unit 14 which, for example, operates photometrically or electrochemically and the results are displayed on a display unit 16. The test element 12 has an analytical field 18 to which blood fluid can be applied which can be heated in a self-regulating manner to a specified target temperature using the thermistor 22 as a PTC heating element fed with a direct current voltage source 20 in the instrument.

In accordance with another embodiment of the present invention shown in FIGS. 2 and 3, the test element 12 which is intended for single analyses, is composed as a test carrier composite part of several foil layers. A capillary sample supply channel 30 is kept free between a cover foil 24 and an intermediate foil 26 by means of a longitudinally divided spacer 28 and the sample supply channel 30 leads to the analytical field 18 on the intermediate foil 26.

Below the intermediate foil 26 a heating chamber 34 is bounded by a cut-out spacer 36 opposite to a bottom foil 32 which protrudes on both sides. The thermistor 22 is integrated as a flat structure into the heating chamber 34 in such a manner that there is a flat heat-conducting connection to the analytical field 18 via the intermediate foil 26 which is a good heat conductor. The thermistor 22 extends over the analytical field 18 and beyond this area over the adjacent section of the sample supply channel 30 in order to enable a preheating of the inflowing sample material. The inlet and outlet of the sample supply channel 30 are kept free of the thermistor to avoid increased evaporation of the sample material. Since only a partition of the test carrier is directly heated, the target temperature can be rapidly reached and the overall heating time can be limited to a few minutes. In order to make electrical contact with the thermistor 22, conducting paths 38 are applied to the bottom foil 32, for example by means of silk-screen printing, which end in laterally exposed connecting tags 40.

The analytical field 18 is formed by a reaction layer provided with dry chemicals which respond with a colour change to an analyte (glucose) in the blood fluid. This change can be detected photometrically through the transparent cover foil 24 by means of the measuring unit 14.

The thermistor 22 is a composite material composed of a conductive mixture for example of a monomer such as methyl cinnamate, 1,6 hexanediol or methyl nicotinate on the one hand and conductive particles such as carbon black particles of for example about 300 nm particle size and about 10 m²/g surface area on the other hand. The proportion of filler is typically less than about 60% in order to prepare a ratio of cold to hot resistance of more than about 1:about 100, and so that the temperature behaviour only shows a slight hysteresis and the composite material can be adequately dispersed before application.

In addition to the proportion of filler, the filler particles can be configured so that they are sufficiently separated from one another in the composite material after heating and exceeding a phase transition point in order to ensure an adequately high heat resistance. Hence, the specific surface area is typically selected to be less than about 10 m²/g. In order to rapidly heat the analytical field 18 to the desired temperature, it is typical to keep the cold resistance of the thermistor low at the given nominal voltage. With a given proportion of electrically conductive particles, the cold resistance can be considerably reduced before application by carefully dispersing the composite material at temperatures above the melting point and by applying ultrasound. In addition, the cold resistance of the heating field described above can be kept low by an adequately long cooling time and by recrystallization before applying the melted conductive mixture.

The heating field can be produced by applying a thin layer of the heated conductive mixture to the area of the heating chamber 34 provided with conducting paths 38 such that a uniform crystallization occurs on cooling and a reproducible electrical contact is ensured between the conducting paths and the conductive mixture. Special graphite conducting paths and in general all conducting paths can be used for this which can be manufactured with highly reproducible resistance values and can be reproducibly contacted by applying the composite material.

The thermistor 22 formed in this manner exhibits a sharp non-linear increase in resistance in the region of a target or switching temperature. Due to the desired high demands on accuracy for analytical determinations of clinically relevant parameters, the temperature deviation should not be substantially more than about 0.1° C. at a defined switching temperature in the range between about 30 and about 40° C. The switching temperature is defined by the composition of the conductive mixture whereas the temperature at the measuring site is additionally determined by suitable design of thickness, properties and exchange area of the test element foils.

When a voltage is applied, current flows and the heating element 22 heats itself. This results in heat being introduced into the analytical field 18 and heat loss into the environment until a phase transition temperature of the conductive mixture is reached which results in a change in volume and a sharp non-linear increase in resistance.

An adequate electrical power supply is necessary for a high temperature stability in order to compensate for the heat loss. On the other hand, the 100-fold increase in the hot resistance compared to the cold resistance ensures that no further heating of the mixture occurs when the target temperature is reached. Hence, a special device for temperature measurement and control of the heating element is unnecessary. However, it is basically also possible to determine the analytical temperature on the basis of the momentary electrical resistance of the thermistor 22 without requiring a separate temperature sensor.

A recess in the intermediate foil 26 may be provided, in which the conductive mixture is introduced in such a manner that it directly adjoins the analytical field 18. Furthermore, embodiments are possible in which the sides and top of the heating field 22 are covered by the analytical field 18. Embodiments are also conceivable in which the heating and analytical field form an integrated unit.

For an in vitro diagnosis a test person contacts the inlet area of the channel 30 of a test element 12 with a drop of blood which is then subjected to an automated processing in a slot of the hand instrument 10. After the result of the measurement has been displayed and optionally stored, the test element 12 is disposed as a consumable.

Disposable cartridges which are used in small floor-model instruments at the patient's bedside or in doctor's offices for example for blood coagulation tests are also potential applications for self-heating test elements.

It is noted that terms like “preferably”, “commonly”, “typically”, and “advantageously” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention.

For the purposes of describing and defining the present invention it is noted that the term “substantially” is utilized herein to represent the inherent degree of uncertainty that may be attributed to any quantitative comparison, value, measurement, or other representation. The term “substantially” is also utilized herein to represent the degree by which a quantitative representation may vary from a stated reference without resulting in a change in the basic function of the subject matter at issue.

Having described the invention in detail and by reference to various specific embodiments thereof, it will be apparent that variations and modifications may be made without departing from the scope of the invention defined in the appended claims. More specifically, although some aspects of the present invention are identified herein as preferred or particularly advantageous, it is contemplated that the present invention is not necessarily limited to these preferred aspects of the invention.

1. A test element for analysing sample material such as blood or urine comprising:
a test carrier which has an analytical area to which sample material can be applied; and
a heating element in heat conducting contact with the analytical area, wherein the heating element integrated into the test carrier is formed by a thermistor which self-heats and self-regulates to a preset target temperature when current flows through it.

2. The test element of claim 1, wherein the thermistor as a cold conductor exhibits a sharp, non-linear increase in resistance in the region of the target temperature as the temperature increases.

3. The test element of claim 1, wherein the thermistor is designed as a heating field.

4. The test element of claim 3, wherein the thermistor is designed as a thin layer heating field.

5. The test element of claim 1, wherein the thermistor is integrated as a flat structure into the test carrier.

6. The test element of claim 5, wherein the thermistor is integrated layer-wise by a coating or printing process.

7. The test element of claim 1, wherein the thermistor is formed from a composite material comprising a binding agent and electrically conductive components incorporated therein.

8. The test element of claim 7, wherein the composite material goes through a phase transition at the target temperature which influences the electrical conductivity.

9. The test element of claim 7, wherein the binding agent is composed of monomers or polymers.

10. The test element of claim 7, wherein the conductive components comprise particles of carbon black, carbon fibres, metal threads or conductive polymer particles.

11. The test element of claim 1, wherein the test carrier is provided as a disposable article for single analyses.

12. The test element of claim 1, wherein the test carrier is formed by a flat substrate.

13. The test element of claim 12, wherein the flat substrate comprises a test strip.

14. The test element of claim 13, wherein the test strip is a composite foil part.

15. The test element of claim 1, wherein the analytical area is at least partially bounded by the thermistor.

16. The test element of claim 1, wherein the analytical area is formed by a reaction field coated with dry chemicals which responds to an analyte in the applied sample material.

17. The test element of claim 1, wherein in order to preheat the sample material, the thermistor extends beyond the analytical area to a sample supply channel of the test carrier.

18. The test element of claim 1, wherein the thermistor also forms a temperature sensor for determining the analytical temperature by means of a resistance measurement.

19. The test element of claim 1, wherein connections for a voltage source that are connected with the thermistor are arranged on the test carrier.

20. The test element of claim 19, wherein the connections for the voltage source are formed by conducting paths.

21. The test element of claim 1, wherein the target temperature is in the range between about 25 to about 50° C.

22. The test element of claim 16, wherein the target temperature is in the range between about 30 to about 40° C.

23. The test element of claim 1, wherein the deviation from the target temperature is less than about 1° C.

24. The test element of claim 1, wherein the analytical area is connected to the thermistor by an intermediate foil in a heat-conducting manner.

25. The test element of claim 1, wherein the thermistor as a flat structure covers only a partition of the test carrier including the analytical area and leaving free the inlet and outlet of a sample supply channel.

26. A measuring instrument for processing the test element as claimed in claim 1 comprising a voltage source, a slot for receiving a test element, a measuring and evaluation unit and a display unit.

27. The measuring instrument of claim 26, wherein said measuring instrument comprises a portable blood sugar measuring instrument or a portable blood coagulation measuring instrument
